(19) United States
(12) Patent Application Publication
(10) Pub. No.: US 2019/0080305 A1
(43) Pub. Date: Mar. 14, 2019

(54) INFORMATION PROCESSING APPARATUS AND DISPLAY METHOD

(71) Applicant: Bank Invoice Corporation, Tokyo (JP)

(72) Inventor: Taro Teshima, Tokyo (JP)

(21) Appl. No.: 16/189,912

(22) Filed: Nov. 13, 2018

Related U.S. Application Data
(63) Continuation of application No. PCT/JP2017/017397, filed on May 8, 2017.

(30) Foreign Application Priority Data
May 29, 2016 (JP) 2016-106877

(51) Int. Cl. G06Q 20/10; G06Q 20/30; G06Q 20/14; G06F 9/54; G06F 3/0482

(52) U.S. Cl. CPC G06Q 20/102; G06Q 20/30; G06F 3/0482; G06F 9/542; G06Q 20/14

(57) ABSTRACT

In an information processing apparatus, an invoice data storage unit stores therein, when receiving invoice data including a designated payment destination, the invoice data in association with the identification information of both the billing and bill-to parties of the invoice data, and a data processing unit displays a progress of processing performed on the invoice data by the billing and bill-to parties on management screens viewed by the billing and bill-to parties, and displays, when receiving a notification indicating that payment is complete from a settlement server apparatus that is configured to make payment to a designated account of the billing party in response to a payment request from the bill-to party, a screen indicating that the payment process for the invoice data is complete on the management screens viewed by the billing and bill-to parties with reference to information stored in the invoice data storage unit.

### CROSS-REFERENCE TO RELATED APPLICATION

This application is a continuation application of International Application PCT/JP2017/017397 filed on May 8, 2017, designating the U.S. and claiming priority from Japanese Patent Application No. 2016-106877 filed on May 29, 2016. The entire contents of both foregoing applications are incorporated herein by reference.

### FIELD

The present invention relates to an information processing apparatus and a display method.

### BACKGROUND

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

In an example of payment for an invoice amount indicated in a received invoice, a payer user makes the payment to a designated account indicated in the invoice through ATM (Automated Teller Machine) or net banking and then notifies a billing party of the payment completion via an Email or the like.

As described above, even when the payer user receives the invoice in electronic data form (pdf data or the like), the payer user is not able to make the payment on the spot but needs to move to another screen or go to the bank for the payment. It would be convenient if the payer user is able to make the payment simply. In addition, it also would be convenient if the billing party is able to know about the completion of the payment more simply.

### SUMMARY

According to one aspect, there is provided an information processing apparatus. The information processing apparatus includes: a memory configured to store therein, upon receipt of payment target data for which a payment destination has been designated, the payment target data in association with identification information of both a billing party and a bill-to party of the payment target data; and a processor configured to perform a process including displaying a progress of processing performed on the payment target data by each of the billing party and the bill-to party, on a first screen viewed by the billing party and a second screen viewed by the bill-to party, and displaying, upon receipt of a notification indicating that payment has been completed from a payment apparatus, a screen indicating that a payment process for the payment target data has been completed, on the first screen and the second screen with reference to information stored in the memory, the payment apparatus being configured to make the payment to a designated account of the billing party in response to a payment request from the bill-to party, wherein the process further includes displaying folders each having a name corresponding to a status indicating a progress of the processing on the first screen and the second screen, and wherein the displaying upon receipt of the notification indicating that the payment has been completed from the payment apparatus includes moving the payment target data for which the payment has been completed, from a folder indicating that payment has not been completed to a folder indicating that payment has been completed on the second screen, and from a folder indicating that payment has not been received to a folder indicating that payment has been received on the first screen.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to one embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data that is stored in an invoice data storage unit.

FIG. 6 is a block diagram for explaining functions of a settlement server apparatus.

FIG. 7 is views for explaining information that is stored in a user data storage unit.

FIG. 8 is a view for explaining information that is displayed in a summary display area.

FIG. 9 is a view for explaining information that is displayed in the summary display area.

FIG. 10 is a view for explaining how to process returned invoice data.

FIG. 11 is a view for explaining how to process invoice data that has been confirmed.

FIG. 12 is a view for explaining a payment process.

### DESCRIPTION OF EMBODIMENTS

Hereinafter, an invoice management system according to one embodiment will be described in detail with reference to the accompanying drawings.

### Embodiment

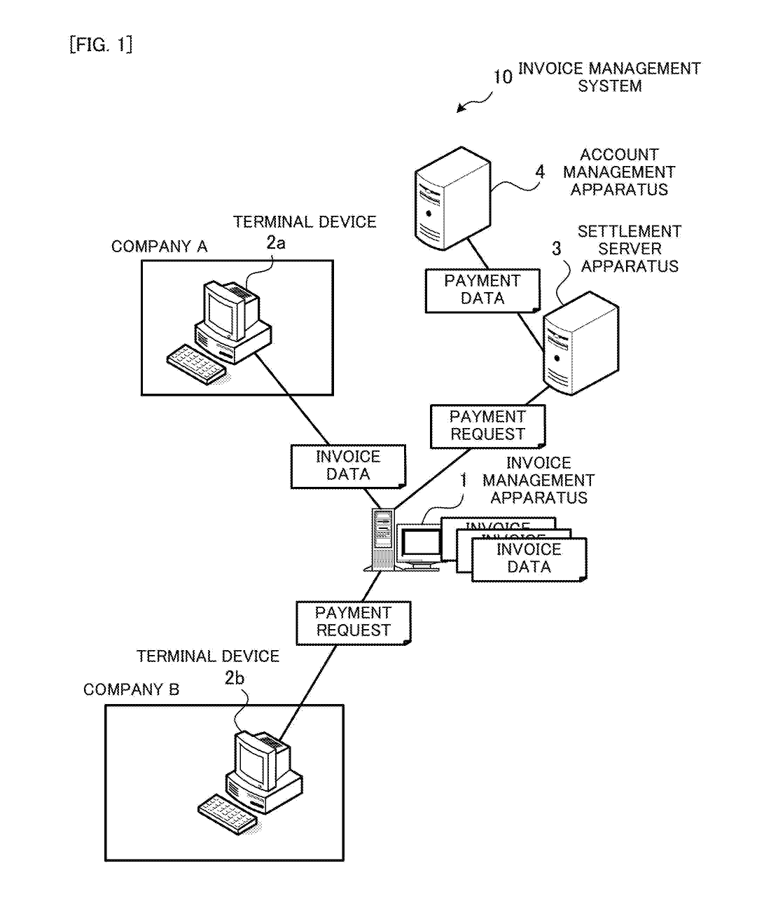

FIG. 1 illustrates an invoice management system according to one embodiment.

In the invoice management system 10 of the present embodiment, an invoice management apparatus 1 is connected to terminal devices 2a and 2b over the Internet, a dedicated network, or another network.

The terminal devices 2a and 2b are placed at accounting departments of different companies. For example, the terminal device 2a is placed at a company A, and the terminal device 2b is placed at a company B.

Examples of the terminal devices 2a and 2b include desktop personnel computers, laptop personnel computers, tablet terminals, and smartphones.

A web program is installed in the invoice management apparatus 1 and the terminal devices 2a and 2b. The terminal devices 2a and 2b communicate invoice data on invoices with the invoice management apparatus 1 through Web browsers. In this connection, this embodiment explains communication of invoice data by way of example, but the invoice data is an example of payment target data. Other examples of payment target data include estimate forms, order forms, purchase order forms, prescriptions, and electronic medical records.

Hereinafter, it is assumed that the invoice management system 10 is used by the individual accounting persons of the companies A and B.

Each accounting personnel of the companies A and B performs user registration to the invoice management apparatus 1 using an assigned Email address and so on, in order to set up a connection to an invoice processing system provided by the invoice management apparatus 1.

After that, for example, the accounting personnel at the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting persons are able to operate their terminal devices 2a and 2b to process invoice data, which is a digitized version of original invoices, via the invoice management apparatus 1. For example, the processing of invoice data include creation, sending, receipt, viewing, editing, and others.

For example, when the accounting personnel at the company A issues an invoice to the company B, the accounting personnel at the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a and 2b. Rather, all invoice data created by the terminal devices 2a and 2b and sent to bill-to parties is held by the invoice management apparatus 1. The invoice data is treated like shared data. The invoice management apparatus 1 gives viewing and editing authorities for the invoice data to the terminal devices 2a and 2b according to necessity.

The above approach makes it possible to digitize and process original invoices electronically, which leads to saving labor for management and storage of paper- or PDF-based invoices.

As described above, invoice data is not communicated directly between the terminal devices 2a and 2b. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a and 2b.

The settlement server apparatus 3 is a server apparatus that is managed by a U bank where the company B has an account, for example.

The settlement server apparatus 3 is connected to the invoice management apparatus 1 and an account management apparatus 4 of another bank over a network. The account management apparatus 4 is managed by an M bank where the company A has an account.

For example, the accounting personnel at the company B operates the terminal device 2b to access the invoice management apparatus 1 and then views an invoice issued from the company A to the company B. Then, the accounting personnel at the company B sends a payment request via the invoice management apparatus 1 to make payment to the designated account at the M bank indicated in the invoice.

When the settlement server apparatus 3 receives the payment request via the invoice management apparatus 1 for the payment from the company B to the company A, the settlement server apparatus 3 sends payment data to the account management apparatus 4. Thereby, the amount indicated in the invoice is credited from the settlement server apparatus 3 to the account of the company A.

Note that the configurations of the apparatuses are not limited to those illustrated. For example, the invoice management apparatus 1 may be designed to have the functions of the settlement server apparatus 3. The account management apparatus 4 may be designed to have the functions of the settlement server apparatus 3. The settlement server apparatus 3 may be designed to have the functions of the account management apparatus 4.

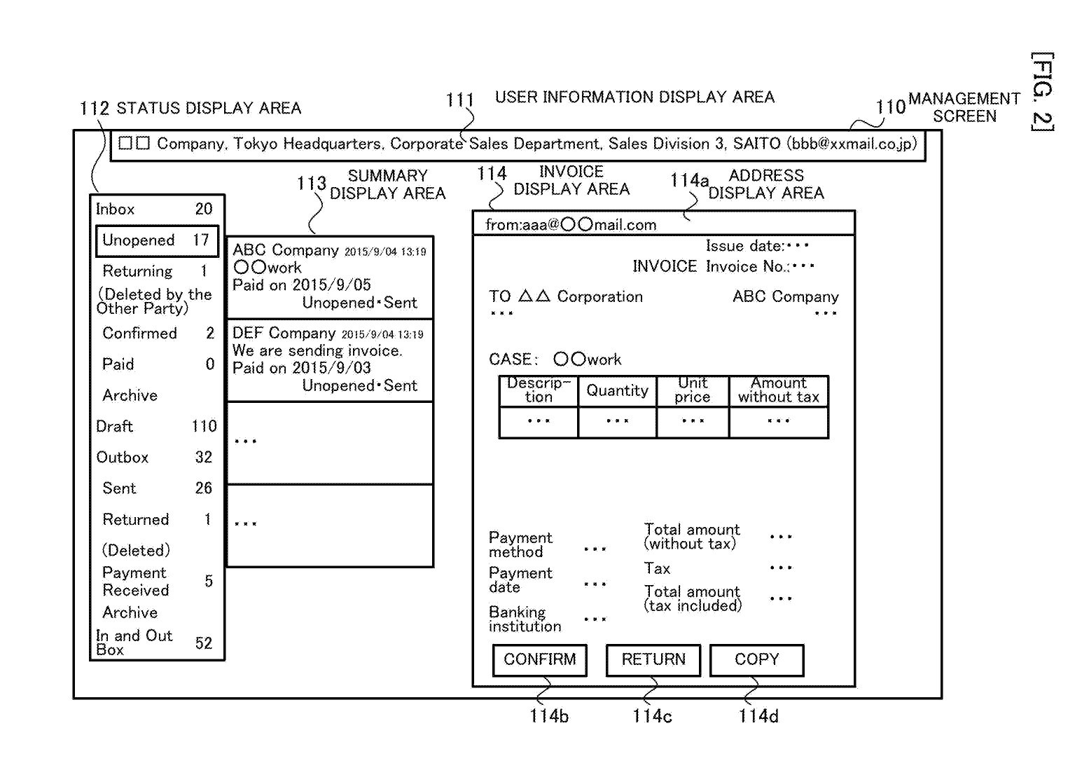

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

By the way, in the above-described example, the accounting personnel at the company A is not able to rewrite invoice data once he/she sends it. In addition, the accounting personnel at the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

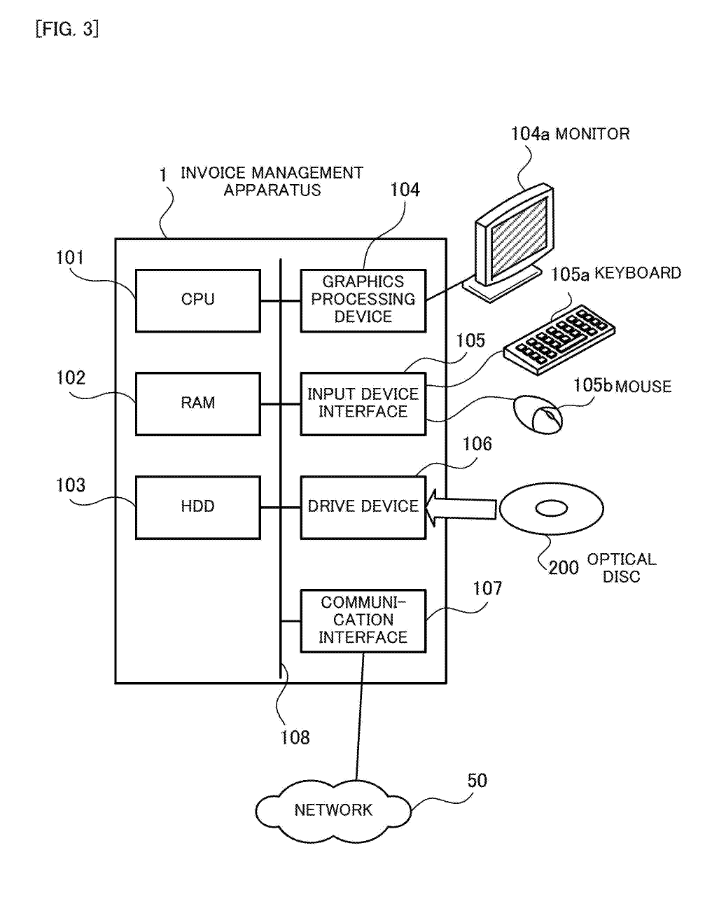

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of OS (operating system) programs and application programs that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. The OS programs, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hardware configuration of the invoice management apparatus 1. The terminal devices 2a and 2b, settlement server apparatus 3, and account management apparatus 4 may be implemented with the same hardware configuration as the invoice management apparatus 1.

The invoice management apparatus 1 having the hardware configuration illustrated in FIG. 3 has the following functions.

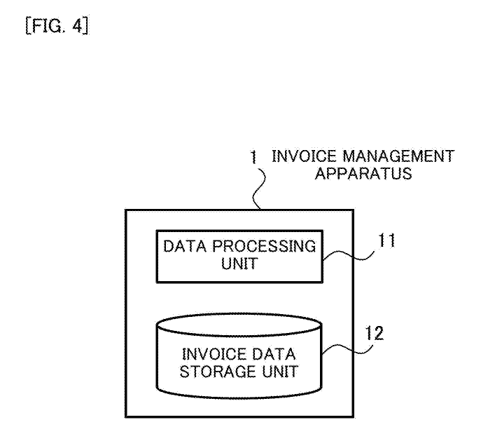

FIG. 4 is a block diagram illustrating functions of the invoice management apparatus according to the present embodiment.

The invoice management apparatus 1 has a data processing unit 11 and an invoice data storage unit 12.

The data processing unit 11 displays the management screen 110 illustrated in FIG. 2 on a monitor connected to the terminal device 2a or the like in accordance with accounting personnel's operations. The data processing unit 11 performs appropriate processing according to operations made to invoice data on the management screen 110. For example, the data processing unit 11 stores invoice data received by the invoice management apparatus 1, in the invoice data storage unit 12.

The invoice data storage unit 12 stores therein invoice data received by the invoice management apparatus 1, by accounting personnel (more specifically, by mail address of accounting personnel). The invoice data received by the invoice management apparatus 1 includes invoice data sent from accounting persons of billing parties to accounting persons of bill-to parties and invoice data drafted by the accounting persons (issuers) of the billing parties.

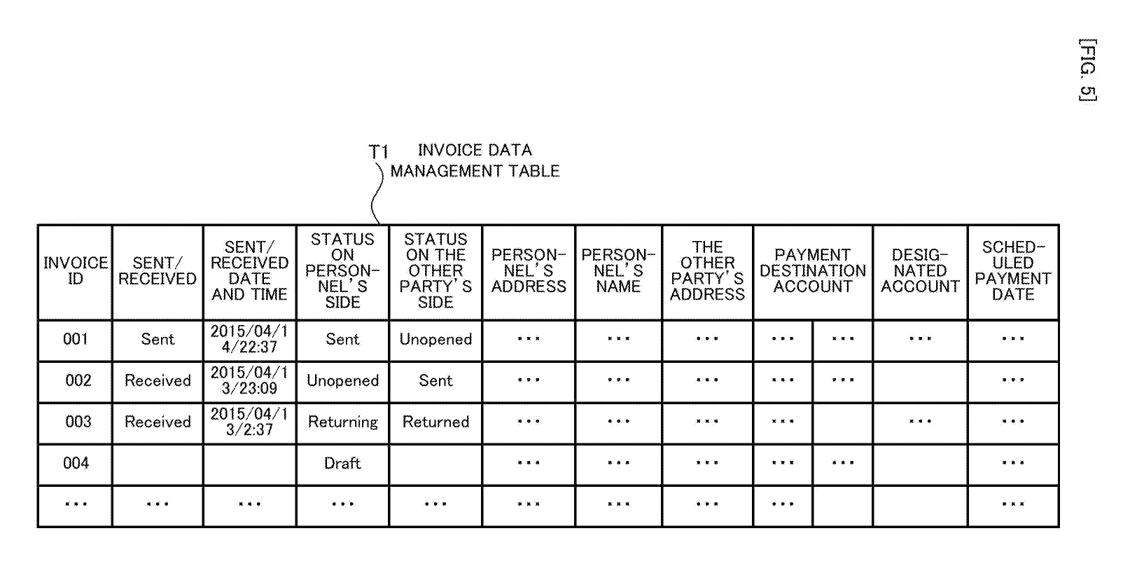

FIG. 5 is a view for explaining an example of invoice data that is stored in the invoice data storage unit.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, and The Other Party's Address, Payment Destination Account, Designated Account, and Scheduled Payment Date. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the department to which the accounting personal belongs and the name of the accounting personnel.

The Other Party's Address column contains the mail address of the accounting personnel of the other party that communicates the invoice data.

In addition to the above-described information, the invoice data management table contains information described in typical invoices, including the company name of the accounting personnel, the company name of the accounting personnel of the other party that communicates the invoice data, the postal codes and addresses of both companies, departments, and others.

The Payment Destination Account column contains at least one of the bank name, branch name, and account number of a payment destination account set by the accounting personnel at the time of creating the invoice data.

The Designated Account column indicates an account to which payment is to be made, selected from payment destination accounts by the accounting personnel of the other party.

The Scheduled Payment Date column contains a scheduled date indicating when an invoice amount is to be credited to an account (for example, a scheduled date designated by the accounting personnel).

The following describes the functions of the settlement server apparatus 3.

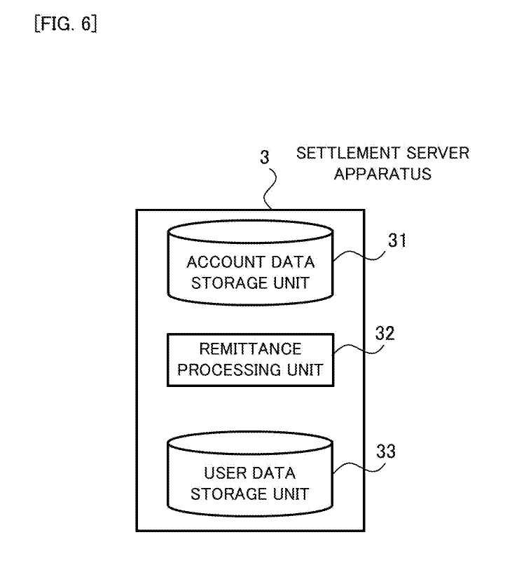

FIG. 6 is a block diagram for explaining functions of the settlement server apparatus.

The settlement server apparatus 3 has an account data storage unit 31, a remittance processing unit 32, and a user data storage unit 33.

The account data storage unit 31 stores therein account information of the company B at the U bank. This account information includes the company name of the company B, branch number, account number, balance, account activity statement, and others.

When the remittance processing unit 32 receives payment request information (will be described later) that an accounting personnel has sent using a terminal device, it performs a remittance process for payment from the bank of the accounting personnel to the payment destination account indicated in the payment request information.

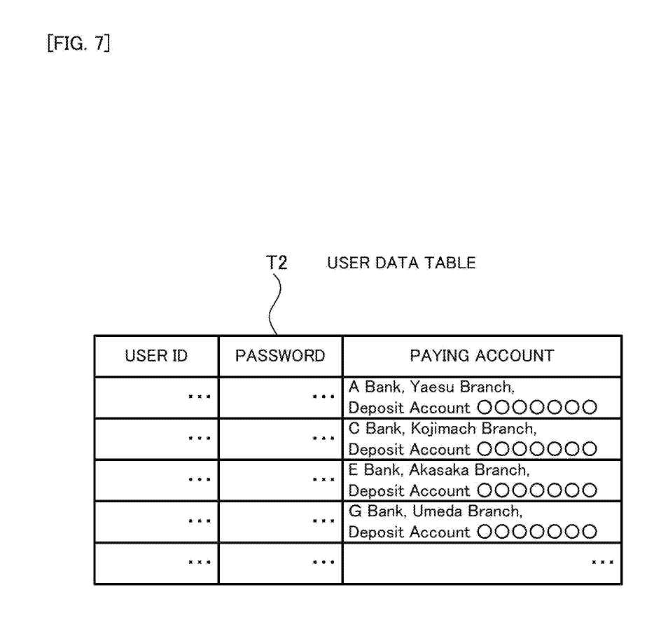

FIG. 7 is a view for explaining information that is stored in the user data storage unit.

The user data storage unit 33 stores therein data in tabular form. The user data table T2 has the following columns: User ID, Password, and Paying Account. Information pieces arranged in horizontal direction are associated with each other.

The User ID column contains a user ID to be used for an accounting personnel to log in to the invoice management apparatus 1.

The Password column contains a password to be used for the accounting personnel to log in to the invoice management apparatus 1.

The Paying Account column indicates a paying account from which the accounting personnel withdraws an amount indicated in an invoice, for payment to the third company.

The following describes the management screen 110 illustrated in FIG. 2.

(Management Screen)

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, and an invoice display area 114.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel, by way of example.

The status display area 112 displays the number of pieces of invoice data that is handled by the accounting personnel that has logged in to the invoice management system, as a folder with a name, for each status indicating a progress of processing.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among the invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the billing party among the invoice data placed in the Inbox folder.

The “Deleted by the Other Party” status is given by the data processing unit 11 to invoice data that has been received and returned by the accounting personnel to the accounting personnel of the billing party, and then deleted by the accounting personnel of the billing party, among the invoice data placed in the Inbox folder.

The “Confirmed” status is given by the data processing unit 11 to invoice data which the accounting personnel has viewed and for which the accounting personnel has selected a Confirm button (will be described later), among the invoice data placed in the Inbox folder.

The “Paid” status is given by the data processing unit 11 to invoice data for which the accounting personnel has selected a Pay button (to be described later), among the invoice data placed in the Inbox folder.

The accounting personnel aggregates the invoice data in the Paid status to confirm the details of the payment (payment statement).

The “Archive” status is given by the data processing unit 11 to invoice data which the accounting personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the content of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened folder, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the billing party, among the invoice data returned from the accounting personnel of the bill-to party.

The “Payment Received” status is given by the data processing unit 11 to invoice data for which the payment has been completed, among the invoice data placed in the Outbox folder. The data processing unit 11 changes the status of the invoice data from “Sent” to “Payment Received” when the payment by the payer is completed.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the content of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a billing party, a case name, a payment date and time, a status on the sender side, and a status on the recipient side.

The same statuses are displayed on the management screens of both the accounting personnel who has sent invoice data and the accounting personnel who has received the invoice data.

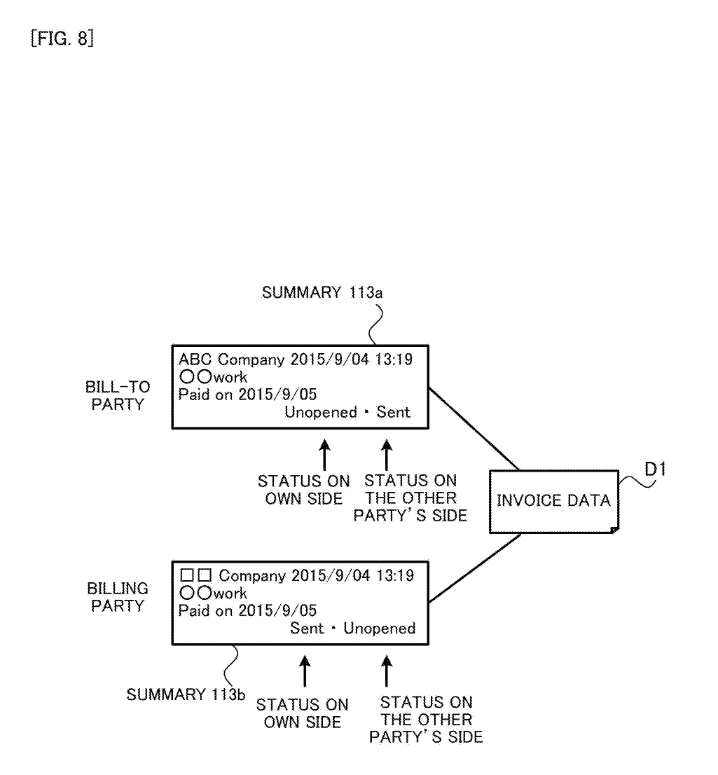

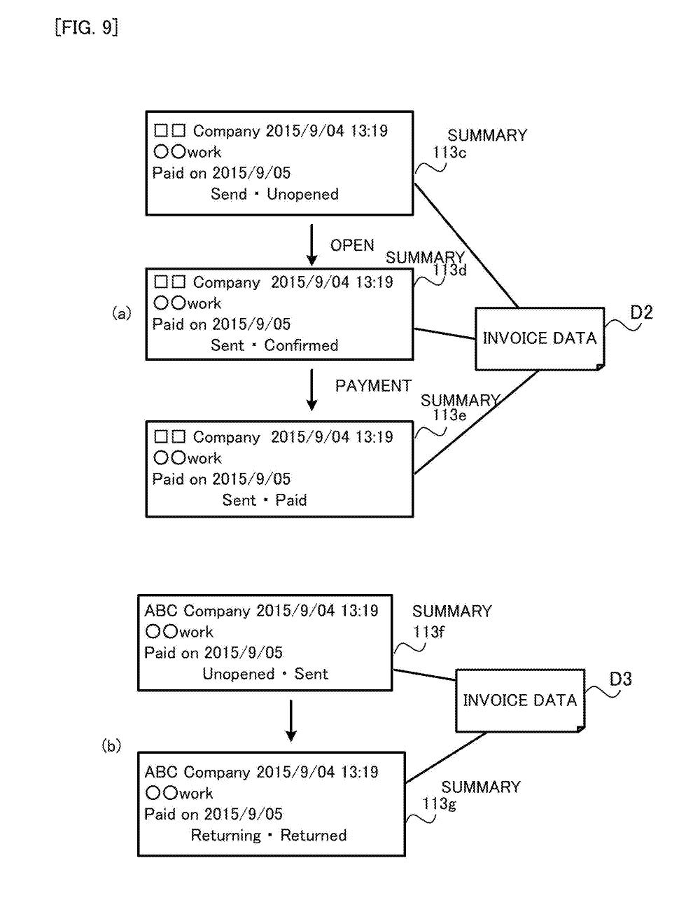

FIGS. 8 and 9 are views for explaining information that is displayed in the summary display area.

FIG. 8 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the billing party.

More specifically, invoice data D1 with a billing party of ABC company and a case name of OO work, as illustrated in FIG. 8, is placed in the “Sent” status in the status display area on the management screen of the terminal device operated by the accounting personnel of the billing party. When the accounting personnel of the billing party selects the “Sent” status in the status display area, the following information is displayed with respect to the invoice data D1 in the summary display area 113: a bill-to party is □□ company, a case name is OO work, a status on the accounting personnel's side of the billing party is “Sent,” and a status on the accounting personnel's side of the bill-to party is “Unopened.”

By confirming status transitions, the accounting personnel of the billing party is able to easily confirm the progress of processing performed by the accounting personnel of the bill-to party. That is to say, the accounting persons of both parties are able to confirm the current status of each invoice data in real-time.

All summaries 113c, 113d, and 113e illustrated in FIG. 9(a) are of invoice data D2.

When the accounting personnel of the bill-to party has viewed the invoice data D2 and selected a Confirm button (will be described later), the data processing unit 11 changes information displayed in the summary display area 113 from the summary 113c to the summary 113d on the management screen 110 of the terminal device operated by the accounting personnel of the billing party.

After that, when the accounting personnel of the bill-to party has made payment for the invoice data D2, the data processing unit 11 changes information displayed in the summary display area 113 from the summary 113d to the summary 113e on the management screen 110 of the terminal device operated by the accounting personnel of the billing party.

As another example, both summaries 113f and 113g illustrated in FIG. 9(b) are of invoice data D3.

When the accounting personnel of the bill-to party has viewed the invoice data D3 and selected a Return button (will be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the content of the invoice data in the invoice display area 114. The content of the invoice to be displayed in the invoice display area 114 is the same as that of existing (paper-based or PDF-based) invoices, except that an address display area 114a and various buttons, which will be described later, are displayed.

Information including at least one payment destination (bank name plus branch name plus account number) is displayed in the invoice display area 114. In the case where a plurality of payment destinations are displayed, the accounting personnel of the bill-to party designates one payment destination before performing a payment process for the invoice data. For this designation of the payment destination, a method of displaying a check box in association with each payment destination previously set by the accounting personnel of the billing party in the invoice display area 114 to allow the accounting personnel of the bill-to party to designate one of the payment destinations, a method of displaying a pull-down list to allow the accounting personnel of the bill-to party to select a desired payment destination, and other methods are considered. The former method is one example of a method of setting payment destinations by the accounting personnel of the billing party, whereas the latter method is one example of a method of designating a payment destination by the accounting personnel of the bill-to party.

The data processing unit 11 registers the payment destination (designated information) designated by the accounting personnel of the bill-to party in the Designated Account column of the invoice data management table T1.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “Confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “Returning” and the Status on the Other Party's Side column to “Returned,” with respect to the invoice data being displayed in the invoice display area 114. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the billing party and the bill-to party in the invoice data. Then, the data processing unit 11 registers information on the created invoice data in the invoice data management table T1. At this time, with respect to the invoice data, “Draft” is set in the Status on Personnel's Side column and a blank is set in the Status on the Other Party's Side column.

(Returns Process)

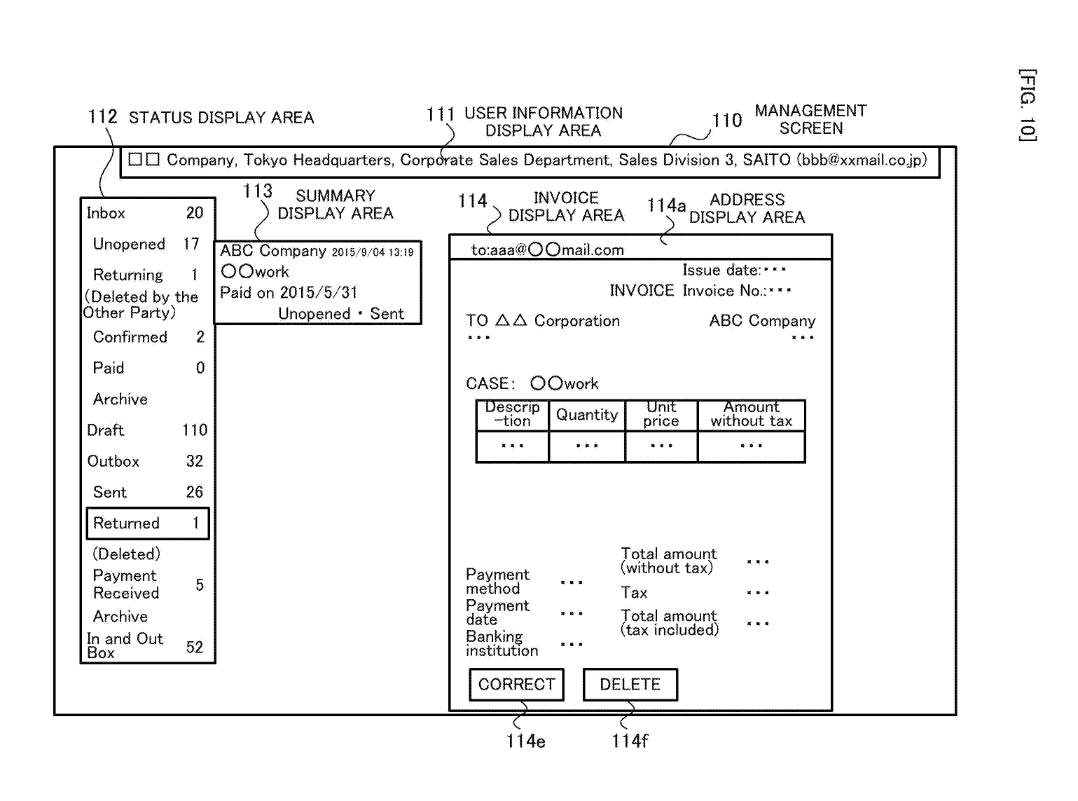

FIG. 10 is a view for explaining how to process returned invoice data.

When the accounting personnel selects the Returned status in the status display area 112 and then selects the summary of an invoice being displayed in the summary display area 113, the data processing unit 11 displays invoice data corresponding to the summary of the selected invoice in the invoice display area 114. In this case, the mail address of the accounting personnel of the bill-to party is displayed in the address display area 114a.

The invoice display area 114 includes a Correct button 114e and a Delete button 114f.

When the accounting personnel selects the Correct button 114e, the data processing unit 11 changes the status of the invoice data being displayed in the invoice display area 114 to “Deleted”. In addition, the data processing unit 11 decreases the number for the “Returned” status by one in the status display area 112. Then, this information is added as a history.

When the accounting personnel selects the Delete button 114f, the data processing unit 11 changes the status of the invoice data being displayed in the invoice display area 114 to “Deleted”. Thereby, the numbers for the “Outbox” folder and “Returned” status are each decreased by one in the status display area 112.

In this connection, the accounting personnel of the billing party and the accounting personnel of the bill-to party are able to view invoice data even after the invoice data is deleted.

More specifically, the accounting personnel of the billing party is able to view deleted invoice data by selecting the “Deleted” status in the status display area 112. On the other hand, the accounting personnel of the bill-to party is able to view deleted invoice data by selecting the “Deleted by the Other Party” status in the status display area 112.

The following describes a process that is performed at the time of payment.

(Payment Process)

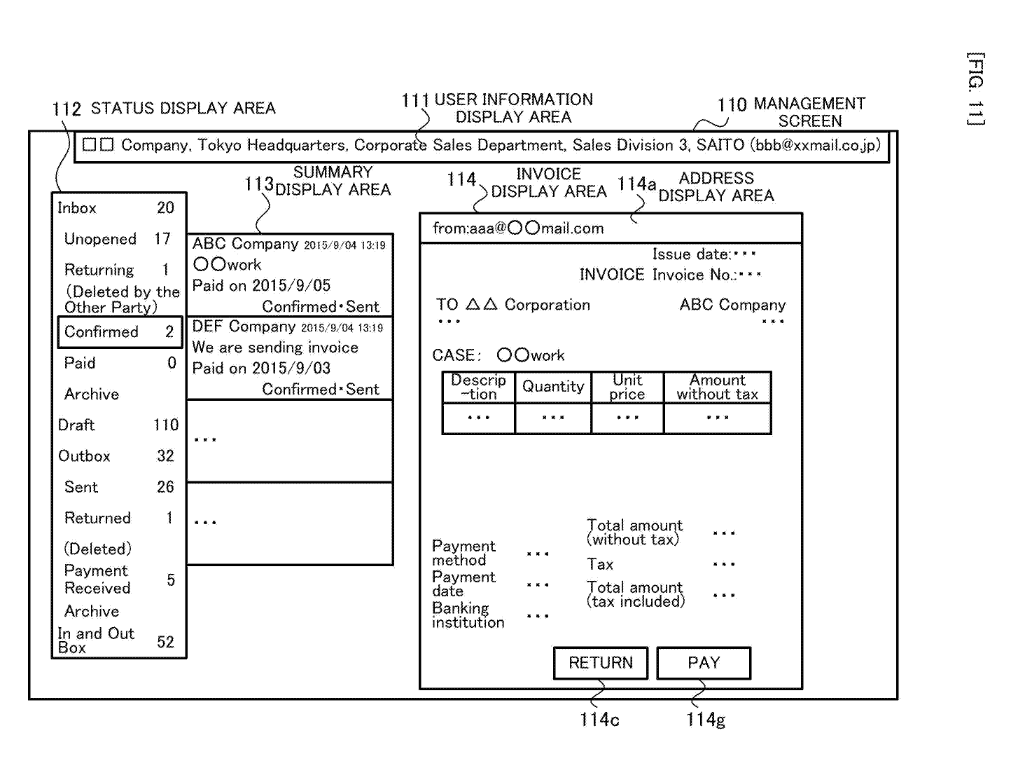

FIG. 11 is a view for explaining how to process invoice data which has been confirmed.

In the case where invoice data placed in the “Confirmed” status in the Inbox folder is selected, a Pay button 114g is displayed in the invoice display area 114. In the case where a plurality of payment destination accounts are indicated in the invoice data, the accounting personnel of the bill-to party designates one payment destination account. Then, when the accounting personnel of the bill-to party selects the Pay button 114g, the data processing unit 11 and settlement server apparatus 3 carries out the payment process.

In this connection, it may be designed so that, after the Pay button 114g is selected, an authentication method (one time password or the like) may be requested to the accounting personnel.

The following describes the payment process assuming that payment is made from the company B to the company A.

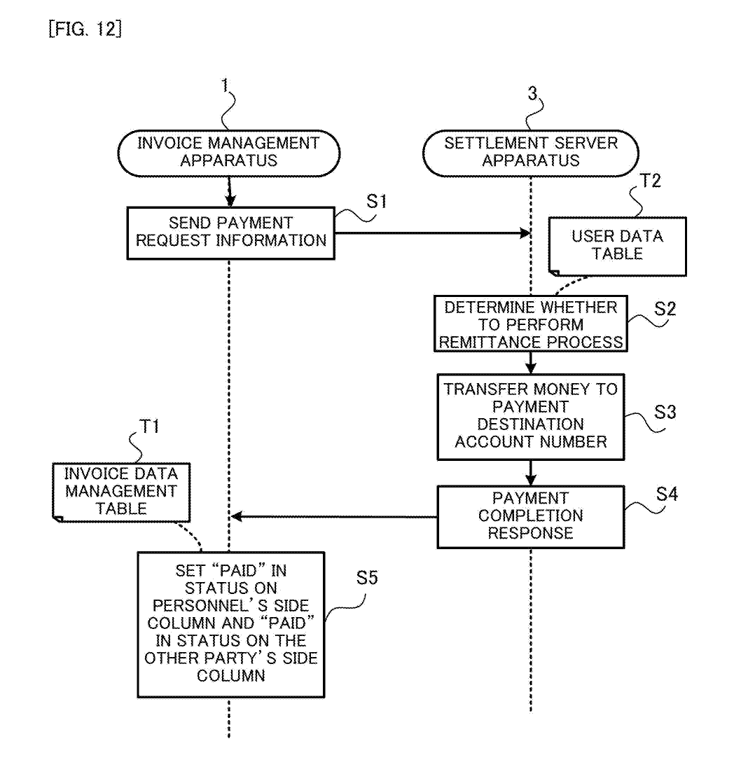

FIG. 12 is a view for explaining the payment process.

(Step S1) The data processing unit 11 sends payment request information to the settlement server apparatus 3. This payment request information includes a user ID and password used by the accounting personnel of the company B to log in to the system, the invoice ID of an invoice for which the payment is to be made, a payment destination account number, and a payment amount.

(Step S2) The settlement server apparatus 3, which has received the payment request information, determines whether to carry out the remittance process using the user ID and password. For example, the remittance processing unit 32 refers to the user data table T2. Then, the remittance processing unit 32 determines whether the combination of the user ID and password included in the payment request information matches a previously registered combination of user ID and password. If the combination of the user ID and password included in the payment request information matches a previously registered combination of user ID and password, the process proceeds to step S3. If the combination of the user ID and password included in the payment request information does not match any previously registered combination of user ID and password, the remittance processing unit 32 notifies the invoice management apparatus 1 that data does not match.

(Step S3) The remittance processing unit 32 transfers the payment amount from the account set in the Paying Account column of the user data table T2 to the payment destination account number indicated in the payment request information. Then, the process proceeds to step S4.

(Step S4) The remittance processing unit 32 sends a payment completion response to the invoice management apparatus 1.

(Step S5) The data processing unit 11 refers to the invoice data management table T1 and sets (changes) the Status on the Other Party's Side column to “Payment Received” with respect to the invoice data. In addition, the data processing unit 11 decreases the number for the “Sent” status by one and increases the number for the “Payment Received” status by one in the status display area 112. By doing so, when the accounting personnel at the company A views the management screen 110, the invoice data for which the payment has been completed is automatically placed in the “Payment Received” status in the status display area 112. In this connection, the management screen 110 viewed by the accounting personnel of the company A is an example of a first screen.

In addition, the data processing unit 11 refers to the invoice data management table T1 and sets the Status on Personnel's Side column to “Paid” with respect to the invoice data. In addition, the data processing unit 11 decreases the number for the “Confirmed” status by one and increases the number for the “Paid” status by one in the status display area 112. By doing so, when the accounting personnel of the company B views the management screen 110, the invoice data for which the payment has been completed is automatically placed in the “Paid” status in the status display area 112. In this connection, the management screen 110 viewed by the accounting personnel of the company B is an example of a second screen.

In this connection, the data processing unit 11 may be designed so as to notify the accounting persons of the company A and company B of the status transitions by displaying them on a screen or by using another method.

The above approach achieves automation of the remittance process.

In this connection, the present embodiment has described an example where transactions are made via the bank. Alternatively, the embodiment is applicate to the case where transactions are made, not via any bank.

Among all invoice data placed in the Inbox and Outbox folders, data other than deleted invoice data, invoice data saved in the archive, and invoice data in the Draft status is placed in the In and Out Box folder.

As described above, the invoice management system 10 makes it possible to achieve automation of a payment process. More specifically, a remittance process is not performed through ATM, net banking, or the like, as in the related art. Rather, an accounting personnel just selects the Pay button 114g, so that the data processing unit 11 (automatically in view of the accounting personnel) carries out the remittance process to transfer money to a designated account. Then, the data processing unit 11 (automatically in view of the accounting persons of both parties) sets the status of the invoice data to information indicating that the payment has been completed.

In addition, invoice data is not communicated directly between the terminal devices 2a and 2b. Rather, all invoice data created using the terminal devices 2a and 2b and sent to bill-to parties is held by the invoice management apparatus 1 and is treated like shared data. Therefore, an accounting personnel of each bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

In this connection, processes performed by the invoice management apparatus 1 may be performed by a plurality of apparatuses in a distributed manner.

In addition, in the present embodiment, the invoice management apparatus 1 has various storage units including the invoice data storage unit 12. Alternatively, each storage unit may be provided at a different location from the data processing unit 11 in cloud-based platform.

Furthermore, invoices include invoices for virtual money, such as Bitcoin, invoices relating to credit information, and others. Invoices themselves may be treated as virtual money.

Heretofore, the information processing apparatus and display method of the present invention have been described as the embodiment illustrated. The invention is not limited thereto, and the components of each unit may be replaced with other components having equivalent functions or other components. In addition, other desired configurations and steps may be added to the invention.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer over a network, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to simplify payment-related processing and payment confirmation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus, comprising:
a memory configured to store therein, upon receipt of payment target data for which a payment destination has been designated, the payment target data in association with identification information of both a billing party and a bill-to party of the payment target data; and
a processor configured to perform a process including
displaying a progress of processing performed on the payment target data by each of the billing party and the bill-to party, on a first screen viewed by the billing party and a second screen viewed by the bill-to party, and
displaying, upon receipt of a notification indicating that payment has been completed from a payment apparatus, a screen indicating that a payment process for the payment target data has been completed, on the first screen and the second screen with reference to information stored in the memory, the payment apparatus being configured to make the payment to a designated account of the billing party in response to a payment request from the bill-to party,
wherein the process further includes displaying folders each having a name corresponding to a status indicating a progress of the processing on the first screen and the second screen, and
wherein the displaying upon receipt of the notification indicating that the payment has been completed from the payment apparatus includes moving the payment target data for which the payment has been completed, from a folder indicating that payment has not been completed to a folder indicating that payment has been completed on the second screen, and from a folder indicating that payment has not been received to a folder indicating that payment has been received on the first screen.

2. The information processing apparatus according to claim 1, wherein the information processing apparatus additionally functions as the payment apparatus.

3. A display method, comprising:
displaying, by a computer, a progress of processing performed on payment target data for which a payment destination has been designated, by each of a billing party and a bill-to party of the payment target data, on a first screen viewed by the billing party and a second screen viewed by the bill-to party; and
displaying, by the computer, upon receipt of a notification indicating that payment has been completed from a payment apparatus, a screen indicating that a payment process for the payment target data has been completed, on the first screen and the second screen with reference to information that is stored in a memory and that associates the payment target data with identification information of both the billing party and the bill-to party of the payment target data, the payment apparatus being configured to make the payment to a designated account of the billing party in response to a payment request from the bill-to party,
wherein folders each having a name corresponding to a status indicating a progress of the processing are displayed on the first screen and the second screen, and
wherein the displaying upon receipt of the notification indicating that the payment has been completed from the payment apparatus includes moving the payment target data for which the payment has been completed, from a folder indicating that payment has not been completed to a folder indicating that payment has been completed on the second screen, and from a folder indicating that payment has not been received to a folder indicating that payment has been received on the first screen.

4. A non-transitory computer-readable recording medium storing a computer program that causes a computer to perform a process comprising:
displaying a progress of processing performed on payment target data for which a payment destination has been designated, by each of a billing party and a bill-to party of the payment target data, on a first screen viewed by the billing party and a second screen viewed by the bill-to party; and
displaying, upon receipt of a notification indicating that payment has been completed from a payment apparatus, a screen indicating that a payment process for the payment target data has been completed, on the first screen and the second screen with reference to information that is stored in a memory and that associates the payment target data with identification information of both the billing party and the bill-to party of the payment target data, the payment apparatus being configured to make the payment to a designated account of the billing party in response to a payment request from the bill-to party,
wherein the process further includes displaying folders each having a name corresponding to a status indicating a progress of the processing on the first screen and the second screen, and
wherein the displaying upon receipt of the notification indicating that the payment has been completed from the payment apparatus includes moving the payment target data for which the payment has been completed, from a folder indicating that payment has not been completed to a folder indicating that payment has been completed on the second screen, and from a folder indicating that payment has not been received to a folder indicating that payment has been received on the first screen.
